(19) United States
(12) Patent Application Publication
(10) Pub. No.: US 2005/0259147 A1
(43) Pub. Date: Nov. 24, 2005

(54) Apparatus and method for adapting 2d and 3d stereoscopic video signal

(76) Inventors: JeHo Nam, Seoul (KR); Jin-Woo Hong, Daejon (KR); Hae-Kwang Kim, Seoul (KR); Rin-Chul Kim, Seoul (KR); Nam-Ik Cho, Seoul (KR); Jae-Joon Kim, Daejon (KR); Man-Bae Kim, Gangwon-do (KR); Hyoung-Joong Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/522,209

(22) PCT Filed: Jul. 16, 2003
(86) PCT No.: PCT/KR03/01411

§ 371 Date: Jan. 14, 2005

(30) Foreign Application Priority Data
Jul. 16, 2002 (KR) 10-2002-0041731

(51) Int. Cl. H04N 15/00

(52) U.S. Cl. 348/43; 345/419

(57) ABSTRACT

An apparatus and method for adapting 2D and 3D stereoscopic video signal. The apparatus for adapting 2D and 3D stereoscopic video signal provides a user with the best experience of digital contents by adapting the digital contents to a particular usage environment including the user characteristic and terminal characteristic. The apparatus allows the efficient delivery of video contents associated with user's adaptation request.

### TECHNICAL FIELD

The present invention relates to an apparatus and method for adapting a 2D or 3D stereoscopic video signal; and, more particularly to an apparatus and method for adapting a 2D or 3D stereoscopic video signal according to user characteristics and user terminal characteristics and a computer-readable recording medium on which a program for executing the method is recorded.

### BACKGROUND ART

The Moving Picture Experts Group (MPEG) suggests a new standard working item, a Digital Item Adaptation (DIA). Digital Item (DI) is a structured digital object with a standardized representation, identification and metadata, and DIA means a process for generating adapted DI by modifying the DI in a resource adaptation engine and/or descriptor adaptation engine.

Here, the resource means an asset that can be identified individually, such as audio or video clips, and image or textual asset. The resource may stand for a physical object, too. Descriptor means information related to the components or items of a DI, such as metadata. Also, a user is meant to include all the producer, rightful person, distributor and consumer of the DI. Media resource means a content that can be expressed digitally directly. In this specification, the term ‘content’, is used in the same meaning as DI, media resource and resource.

While two-dimensional (2D) video has been a general media so far, three-dimensional (3D) video has been also introduced in the field of information and telecommunications. The stereoscopic image and video are easily found at many Internet sites, DVD titles, etc. Following this situation, MPEG has been interested in the stereoscopic video processing. The compression scheme of the stereoscopic video has been standardized in MPEG-2, i.e., “Final Text of 12818-2/AMD3 (MPEG-2 multiview profile)” at International Standard Organization/International Electrotechnical committee (ISO/IEC) JTC1/SC29/WG11. The MPEG-2 multiview profile (MVP) was defined in 1996 as an amendment to the MPEG-2 standard with the main application area being stereoscopic TV. The MVP extends the well-known hybrid coding towards exploitation of inter-viewchannel redundancies by implicitly defining disparity-compensated prediction. The main new elements are the definition of usage of a temporal scalability (TS) mode for multi-camera sequences, and the definition of acquisition parameters in an MPEG-2 syntax. The TS mode was originally developed to allow the joint encoding of base layer stream having a low frame rate and an enhancement layer stream having additional video frames. If both streams are available, decoded video can be reproduced with full frame rate. In the TS mode, temporal prediction of enhancement layer macroblocks can be performed either from a base layer frame, or from the recently reconstructed enhancement layer frame.

In general, the stereoscopic video is produced using a stereoscopic camera with a pair of left and right camera. The stereoscopic video is stored or transmitted to the user. Unlike the stereoscopic video, the 3D stereoscopic conversion of 2D video (2D/3D stereoscopic video conversion) makes it possible for users to watch 3D stereoscopic video from ordinary 2D video data. For instance, users can enjoy 3D stereoscopic movies from TV, VCD, DVD, etc. Unlike general stereoscopic images acquired from a stereoscopic camera, an essential difference is that the stereoscopic conversion is to generate a stereoscopic image from a single 2D image. As well, the 2D video can be extracted from the 3D stereoscopic video acquired from a stereoscopic camera (3D stereoscopic/2D video conversion).

Conventional technologies have a problem that they cannot provide a single-source multi-use environment where one video content is adapted to and used in different usage environments by using video content usage information, i.e., user characteristics, natural environment of a user, and capability of a user terminal.

Here, ‘a single source’ denotes a content generated in a multimedia source, and ‘multi-use’ means various user terminals having diverse usage environments that consume the ‘single source’ adaptively to their usage environment.

Single-source multi-use is advantageous because it can provide diversified contents with only one content by adapting the content to different usage environments, and further, it can reduce the network bandwidth efficiently when it provides the single source adapted to the various usage environments.

Therefore, the content provider can save unnecessary cost for producing and transmitting a plurality of contents to match various usage environments. On the other hand, the content consumers can be provided with a video content optimized for their diverse usage environments.

However, conventional technologies do not take the advantage of single-source multi-user. That is, the conventional technologies transmit video contents indiscriminately without considering the usage environment, such as user characteristics and user terminal characteristics. The user terminal having a video player application consumes the video content with a format unchanged as received from the multimedia source. Therefore, the conventional technologies can not support the single-source multi-use environment.

If a multimedia source provides a multimedia content in consideration of various usage environments to overcome the problems of the conventional technologies and support the single-source multi-use environment, much load is applied to the generation and transmission of the content.

### DISCLOSURE OF INVENTION

It is, therefore, an object of the present invention to provide an apparatus and method for adapting a video content to usage environment by using information pre-describing the usage environment of a user terminal that consumes the video content.

In accordance with one aspect of the present invention, there is provided an apparatus for adapting a two-dimensional (2D) or three-dimensional (3D) stereoscopic video signal for single-source multi-use, including: a video usage environment information managing unit for acquiring, describing and managing user characteristic information from a user terminal; and a video adaptation unit for adapting the video signal to the video usage environment information to generate an adapted 2D video signal or a 3D stereoscopic video signal and outputting the adapted video signal to the user terminal.

In accordance with another aspect of the present invention, there is provided an apparatus for adapting a 2D video signal or a 3D stereoscopic video signal for single-source multi-use, including: a video usage environment information managing unit for acquiring, describing and managing user terminal characteristic information from a user terminal; and a video adaptation unit for adapting the video signal to the video usage environment information to generate an adapted 2D video signal or 3D stereoscopic video signal and outputting the adapted video signal to the user terminal.

In accordance with one aspect of the present invention, there is provided a method for adapting a 2D video signal or a 3D stereoscopic video signal for single-source multi-use, including the steps of: a) acquiring, describing and managing user characteristic information from a user terminal; and b) adapting the video signal to the video usage environment information to generate an adapted 2D video signal or a 3D stereoscopic video signal and outputting the adapted video signal to the user terminal.

In accordance with another aspect of the present invention, there is provided a method for adapting a 2D video signal or a 3D stereoscopic video signal for single-source multi-use, including the steps of: a) acquiring, describing and managing user terminal characteristic information from a user terminal; and b) adapting the video signal to the video usage environment information to generate an adapted 2D video signal or 3D stereoscopic video signal and outputting the adapted video signal to the user terminal.

In accordance with one aspect of the present invention, there is provided a computer-readable recording medium for recording a program that implements a method for adapting a 2D video signal or a 3D stereoscopic video signal for single-source multi-use, the method including the steps of:
a) acquiring, describing and managing user characteristic information from a user terminal; and b) adapting the video signal to the video usage environment information to generate an adapted 2D video signal or 3D stereoscopic video signal and outputting the adapted video signal to the user terminal.

In accordance with another aspect of the present invention, there is provided a computer-readable recording medium for recording a program that implements a method for adapting a 2D video signal or a 3D stereoscopic video signal for single-source multi-use, the method including the steps of: a) acquiring, describing and managing user terminal characteristic information from a user terminal; and b) adapting the video signal to the video usage environment information to generate an adapted 2D video signal or 3D stereoscopic video signal and outputting the adapted video signal to the user terminal.

### BRIEF DESCRIPTION OF DRAWINGS

The above and other objects and features of the present invention will become apparent from the following description of the preferred embodiments given in conjunction with the accompanying drawings, in which:

FIG. 1 is a block diagram illustrating a user terminal provided with a video adaptation apparatus in accordance with an embodiment of the present invention;

FIG. 2 is a block diagram describing a user terminal that can be embodied by using the video adaptation apparatus of FIG. 1 in accordance with an embodiment of the present invention;

FIG. 3 is a flowchart illustrating a video adaptation process performed in the video adaptation apparatus of FIG. 1; FIG. 4 is a flowchart depicting the adaptation process of FIG. 3;

FIG. 5 is a flowchart showing an adaptation process of 2D video signal and 3D stereoscopic video signal in accordance with a preferred embodiment of the present invention;

FIG. 6 is an exemplary diagram depicting parallaxes in accordance with the present invention;

FIG. 7 is an exemplary diagram depicting a range of depth in accordance with the present invention; and

FIGS. 8A to 8C are exemplary diagrams illustrating rendering methods of 3D stereoscopic video signal in accordance with the present invention.

### BEST MODE FOR CARRYING OUT THE INVENTION

Other objects and aspects of the invention will become apparent from the following description of the embodiments with reference to the accompanying drawings, which is set forth hereinafter.

Following description exemplifies only the principles of the present invention. Even if they are not described or illustrated clearly in the present specification, one of ordinary skill in the art can embody the principles of the present invention and invent various apparatuses within the concept and scope of the present invention.

The conditional terms and embodiments presented in the present specification are intended only to make understood the concept of the present invention, and they are not limited to the embodiments and conditions mentioned in the specification.

In addition, all the detailed description on the principles, viewpoints and embodiments and particular embodiments of the present invention should be understood to include structural and functional equivalents to them. The equivalents include not only the currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flowcharts, state conversion diagrams, pseudo codes, and the like can be expressed substantially in a computer-readable recording media, and whether or not a computer or a processor is described in the specification distinctively, they should be understood to express a process operated by a computer or a processor.

The functions of various devices illustrated in the drawings including a functional block expressed as a processor or a similar concept can be provided not only by using dedicated hardware, but also by using hardware capable of running proper software. When the function is provided by a processor, the provider may be a single dedicated processor, single shared processor, or a plurality of individual processors, part of which can be shared.

The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

In the claims of the present specification, an element expressed as a “means” for performing a function described in the detailed description is intended to include all methods for performing the function including all formats of software, such as a combination of circuits that performs the function, firmware/microcode, and the like. To perform the intended function, the element is cooperated with a proper circuit for performing the software. The claimed invention includes diverse means for performing particular functions, and the means are connected with each other in a method requested in the claims. Therefore, any means that can provide the function should be understood to be an equivalent to what is figured out from the present specification.

Other objects and aspects of the invention will become apparent from the following description of the embodiments with reference to the accompanying drawings, which is set forth hereinafter. The same reference numeral is given to the same element, although the element appears in different drawings. In addition, if further detailed description on the related prior arts is thought to blur the point of the present invention, the description is omitted. Hereafter, preferred embodiments of the present invention will be described in detail.

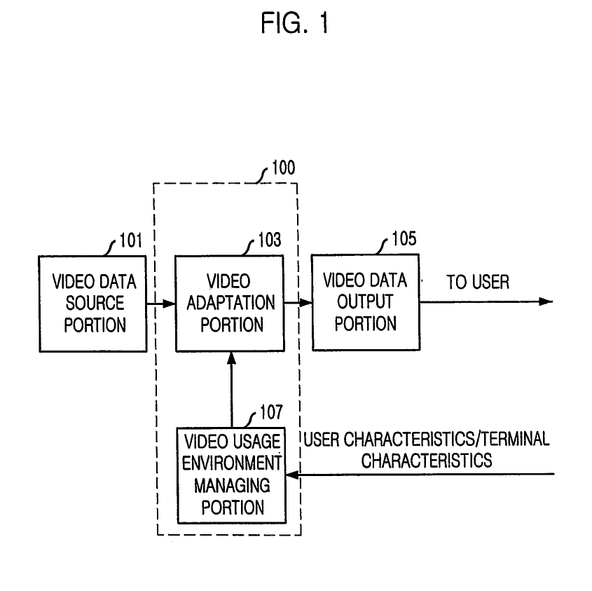

FIG. 1 is a block diagram illustrating a user terminal provided with a video adaptation apparatus in accordance with an embodiment of the present invention. Referring to FIG. 1, the video adaptation apparatus 100 of the embodiment of the present invention includes a video adaptation portion 103 and a video usage environment information managing portion 107. Each of the video adaptation portion 103 and the video usage environment information managing portion 107 can be provided to a video processing system independently from each other.

The video processing system includes laptops, notebooks, desktops, workstations, mainframe computers and other types of computers. Data processing or signal processing systems, such as Personal Digital Assistant (PDA) and wireless communication mobile stations, are included in the video processing system.

The video system may be any one arbitrary selected from the nodes that form a network path, e.g., a multimedia source node system, a multimedia relay node system, and an end user terminal.

The end user terminal includes a video player, such as Windows Media Player and Real Player.

For example, if the video adaptation apparatus 100 is mounted on the multimedia source node system and operated, it receives pre-described information on the usage environment in which the video content is consumed, adapts the video content to the usage environment, and transmits the adapted content to the end user terminal.

With respect to the video encoding process, a process of the video adaptation apparatus 100 processing video data, the International Organization for Standardization/International Electrotechnical Committee (ISO/IEC) standard document of the technical committee of the ISO/IEC may be included as part of the present specification as far as it is helpful in describing the functions and operations of the elements in the embodiment of the present invention.

A video data source portion 101 receives video data generated in a multimedia source. The video data source portion 101 may be included in the multimedia source node system, or a multimedia relay node system that receives video data transmitted from the multimedia source node system through a wired/wireless network, or in the end user terminal.

The video adaptation portion 103 receives video data from the video data source portion 101 and adapts the video data to the usage environment, e.g., user characteristics and user terminal characteristics, by using the usage environment information pre-described by the video usage environment information managing portion 107.

The video usage environment information managing portion 107 collects information from a user and a user terminal, and then describes and manages usage environment is information in advance.

The video content/metadata output portion 105 outputs video data adapted by the video adaptation portion 103. The outputted video data may be transmitted to a video player of the end user terminal, or to a multimedia relay node system or the end user terminal through a wired/wireless network.

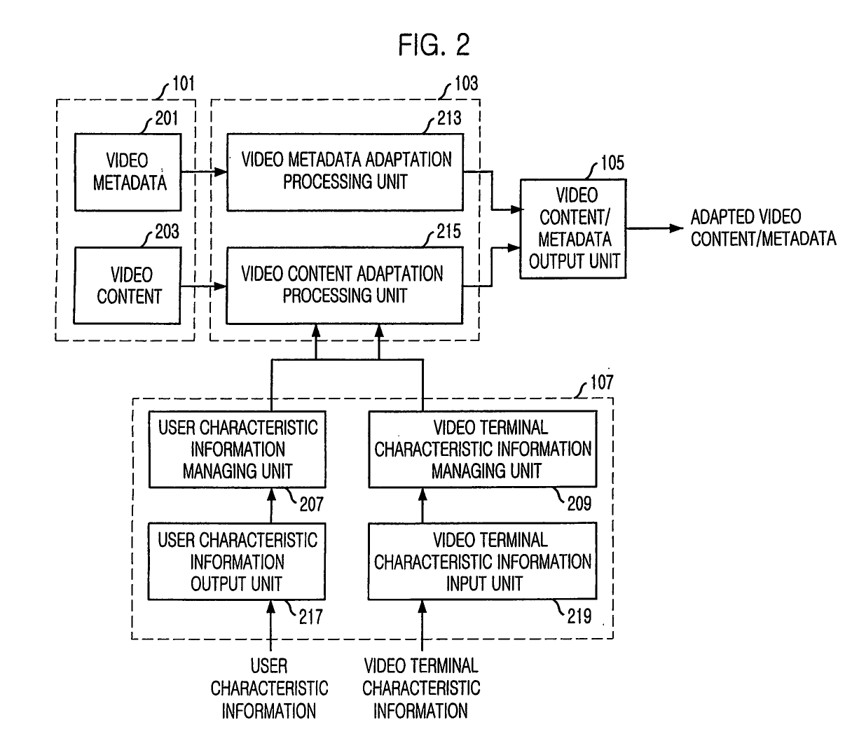

FIG. 2 is a block diagram describing a user terminal that can be embodied by using the video adaptation apparatus of FIG. 1 in accordance with an embodiment of the present invention. As illustrated in the drawing, the video data source portion 101 includes video metadata 201 and a video content 203.

The video data source portion 101 collects video contents and metadata from a multimedia source and stores them. Here, the video content and the metadata are obtained from terrestrial, satellite or cable TV signal, network such as the Internet, or a recording medium such as a VCR, CD or DVD. The video content also includes two-dimensional (2D) video or three-dimensional (3D) stereoscopic video transmitted in the form of streaming or broadcasting.

The video metadata 201 is a description data related to video media information, such as the encoding method of the video content, size of file, bit-rate, frame/second and resolution, and corresponding content information such as, title, author, produced time and place, genre and rating of video content. The video metadata can be defined and described based on extensible Markup Language (XML) schema.

The video usage environment information managing portion 107 includes a user characteristic information managing unit 207, a user characteristic information input unit 217, a video terminal characteristic information managing unit 209 and a video terminal characteristic information input unit 219.

The user characteristic information managing unit 207 receives information of user characteristics, such as depth and parallax of 3D stereoscopic video content in case of 2D/3D video conversion, or left and right inter video in case of 3D/2D video conversion according to preference or favor of user from the user terminal through the user characteristic information input unit 217, and manages the information of user characteristics. The inputted user characteristic information is managed in a language that can be readable mechanically, for example, an XML format.

The video terminal characteristic information managing unit 209 receives terminal characteristic information from the video terminal characteristic information input unit 219 and manages the terminal characteristic information. The terminal characteristic information is managed in a language that can be readable mechanically, for example, an XML format.

The video terminal characteristic information input unit 219 transmits the terminal characteristic information that is set in advance or inputted by the user to the video terminal characteristic information managing unit 209. The video usage environment information managing portion 107 receives user terminal characteristic information collected to play a 3D stereoscopic video signal such as whether display hardware of the user terminal is monoscopic or stereoscopic or whether a video decoder is a stereoscopic MPEG-2, stereoscopic MPEG-4 or stereoscopic audio video interleave (AVI) video decoder, or whether a rendering method is interlaced, sync-double, page-f lipping, red-blue anaglyph, red-cyan anaglyph, or red-yellow anaglyph.

The video adaptation portion 103 includes a video metadata adaptation unit 213 and a video content adaptation unit 215.

The video content adaptation unit 215 parses the user characteristic information and the video terminal characteristic information that are managed in the user characteristic information input unit 217 and the video terminal characteristic information managing unit 209, respectively, and then adapts the video content suitably to the user characteristics and the terminal characteristics.

That is, the video content adaptation unit 215 receives and parses the user characteristic information. Then, the user preference such as depth, parallax and the number of maximum delay frames are reflected in an adaptation signal processing process and the 2D video content is converted to the 3D stereoscopic video content.

Also, when the inputted 3D stereoscopic video signal is converted to the 2D video signal, left image, right image or synthesized image of the inputted 3D stereoscopic video signal is reflected and the 3D stereoscopic video signal is adapted to the 2D video signal according to the preference information of user.

Also, the video content adaptation unit 215 receives the user characteristic information in an XML format from the video terminal characteristic information managing unit 209 and parses the user characteristic information. Then, the video content adaptation unit 215 executes adaptation of the 3D stereoscopic video signal according to the user terminal characteristics information such as kinds of display device, 3D stereoscopic video decoder and rendering method.

The video metadata adaptation processing unit 213 provides metadata needed in the video content adaptation process to the video content adaptation unit 215, and adapts the content of corresponding video metadata information based on the result of video content adaptation.

That is, the video metadata adaptation processing unit 213 provides metadata needed in the 2D video content or 3D stereoscopic video adaptation process to the video content adaptation unit 215. Then, the video metadata adaptation processing unit 213 updates, writes or stores 2D video metadata or 3D stereoscopic video metadata based on the result of video content adaptation.

The video content/metadata output unit 105 outputs contents and metadata of 2D video or 3D stereoscopic video adapted according to the user characteristic and the terminal characteristic.

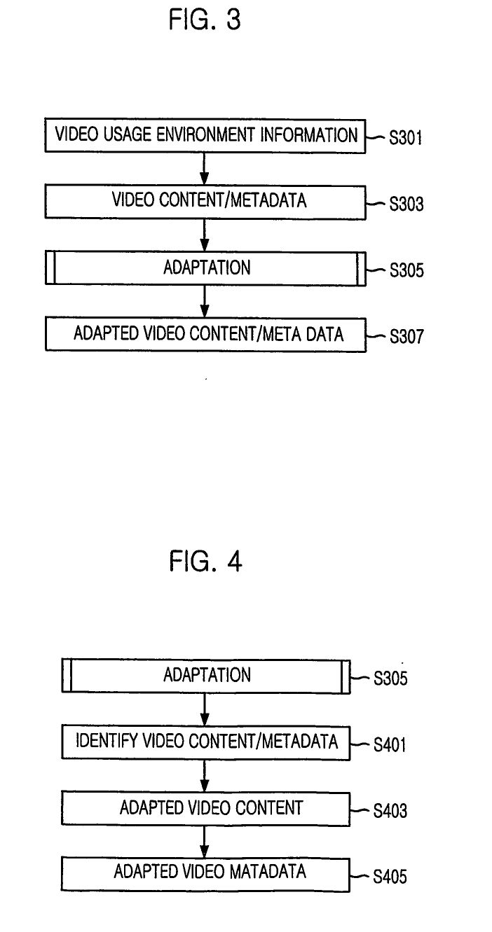

FIG. 3 is a flowchart illustrating a video adaptation process performed in the video adaptation apparatus of FIG. 1. Referring to FIG. 3, at step S301, the video usage environment information managing portion 107 acquires video usage environment information from a user and a user terminal, and prescribes information on user characteristics, user terminal characteristics.

Subsequently, at step S303, the video data source portion 101 receives video content/metadata. At step S305, the video adaptation portion 103 adapts the video content/metadata received at the step S303 suitably to the usage environment, i.e., user characteristics, user terminal characteristics, by using the usage environment information described at the step S301.

At step S307, the video content/metadata output portion 105 outputs 2D video data or 3D stereoscopic video adapted at the step S305.

FIG. 4 is a flowchart depicting the adaptation process (S305) of FIG. 3.

Referring to FIG. 4, at step S401, the video adaptation portion 103 identifies 2D video content or 3D stereoscopic video content and video metadata that the video data source portion 101 has received. At step S403, the video adaptation portion 103 adapts the 2D video content or 3D stereoscopic video content that needs to be adapted suitably to the user characteristics, natural environment of the user and user terminal capability. At step S405, the video adaptation portion 103 adapts the video metadata corresponding to the 2D video content or 3D stereoscopic video content based on the result of the video content adaptation, which is performed at the step S403.

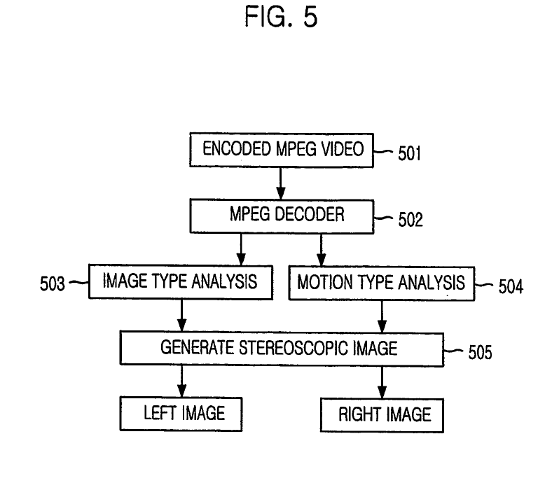

FIG. 5 is a flowchart showing an adaptation process of 2D video signal and 3D stereoscopic video signal in accordance with a preferred embodiment of the present invention.

Referring to FIG. 5, a decoder 502 receives an encoded MPEG video signal 501, extracts motion vector from each 16×16 macro block and executes image type analysis 503 and motion type analysis 504.

During the image type analysis, it is determined whether an image is a static image, a horizontal motion image, a non-horizontal motion image or a fast motion image.

During the motion type analysis, motion of camera and an object of the moving image are determined.

3D stereoscopic video 505 is generated from 2D video by the image type analysis 503 and the motion type analysis 504.

An image pixel or 3D depth information of a block is obtained from the static image based upon intensity, texture and other characteristics. The obtained depth information is used to construct a right image or a left image.

A current image or a delayed image is chosen from the horizontal motion image. The chosen image is suitably displayed to a right or left eye of the user according to a motion type of the horizontal motion image determined by the motion type analysis 504.

A stereoscopic image is generated from the non-horizontal motion image according to the motion and the depth information Herein, a structure of description information that is managed in the video usage environment information managing portion 107 is described.

In accordance with the present invention, in order to adapt a 2D video content or 3D stereoscopic video content to usage environment by using pre-described information of usage environment where the 2D video content or 3D stereoscopic video content is consumed, usage environment information, e.g., the information StereoscopicVideoConversionType on the user characteristics, the information StereoscopicVideoDisplayType on the terminal characteristics should be managed.

The information on the user characteristics describes user preference on the 2D video or 3D stereoscopic video conversion. Shown below is an example of syntax that expresses a description information structure of the user characteristics which is managed by the video usage environment information managing portion 107, shown in FIG. 1, based on the definition of the XML schema.

```
      complexType name=“StereoscopicVideoConversionType”>
      <sequence>
      <element
              name=“From2DTo3DStereoscopic” minOccurs=“0”>
      <complexType>
      <sequence>
      <element name=“ParallaxType”>
      <simpleType>
      <restriction base=“string”>
      <enumeration value=“Positive”/>
      <enumeration value=“Negative”/>
      </restriction>
      </simpleType>
      </element>
      <element
              name=“DepthRange” type=“mpeg7:zeroToOneType”/>
      <element
            name=“MaxDelayedFrame”
type=“nonNegativeInteger”/>
      </sequence>
      </complexType>
      </element>
      <element
              name=“From3DStereoscopicTo2D” minOccurs=“0”>
      <complexType>
      <sequence>
      <element name=“LeftRightInterVideo”>
      <simpleType>
      <restriction base=“string”>
      <enumeration value=“Left”/>
      <enumeration value=“Right”/>
      <enumeration value=“Intermediate”/>
      </restriction>
      </simpleType>
      </element>
      </sequence>
      </complexType>
      </element>
      </sequence>
      </complexType>
```

Table 1 shows elements of user characteristics.

TABLE 1

| | Elements | Data type |
|---|---|---|
| Stereoscopic | Parallax Type | String; |
| Video Conversion | | Positive or Negative |
| Type | Depth Range | Mpeg7:zeroToOneType |
| | Max Delayed Frame | Nonnegative Integer |
| | Left Right Inter | String; Left, Right, |
| | Video | Intermediate |

Referring to the exemplary syntax described by the definition of an XML schema, the user characteristics of the present invention are divided into two categories such as a conversion case from 2D video to 3D stereoscopic video From 2D To 3D Stereoscopic and a conversion case from 3D stereoscopic video to 2D video From 3D Stereoscopic To 2D.

In case of the conversion from 2D video to 3D stereoscopic video, the PrallaxType represents negative parallax or positive parallax which is the user preference to the type of parallaxes.

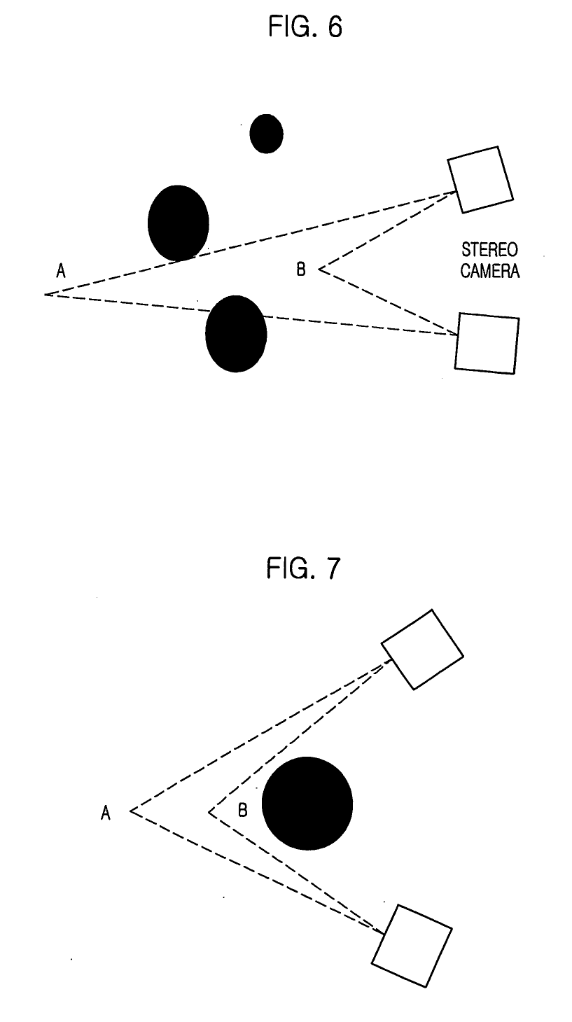

FIG. 6 is an exemplary diagram depicting parallaxes in accordance with the present invention.

Referring to FIG. 6, A represents the negative parallax and B represents the positive parallax. That is, the 3D depth of objects, i.e., three circles, is perceived between the monitor screen and human eyes in case of the negative parallax and the objects are perceived behind the screen in case of the positive parallax.

Also, in case of conversion from a 2D video signal to a 3D stereoscopic video signal, DepthRange represents a user preference to the parallax depth of the 3D stereoscopic video signal. The parallax can be increased or decreased according to determination of the range of 3D depth.

FIG. 7 is an exemplary diagram depicting range of depth in accordance with the present invention.

Referring to FIG. 7, at a convergence point A, the wider depth is perceived compared with B.

Also, in case of conversion from a 2D video signal to a 3D stereoscopic video signal, MaxDelayedFrame represents the maximum number of delayed frames.

One of the stereoscopic conversion schemes is to make use of a delayed image. That is, the image sequence is { . . . , Iₖ₋₃, Iₖ₋₂, Iₖ₋₁, Iₖ, . . . } and Iₖ is the current frame. One of the previous frames, Iₖ₋ₙ(n>1) is chosen. Then, a stereoscopic image consists of Iₖ and Iₖ₋ₙ. the maximum number n of delayed frames is determined by MaxDelayedFrame.

In case of conversion from a 3D stereoscopic video signal to a 2D video signal, LeftRightInterVideo represents a user preference among left image, right image or synthesized image in order to obtain an image having better quality.

The information on the user terminal characteristics represents characteristics information such as whether display hardware of the user terminal is monoscopic or stereoscopic or whether a video decoder is a stereoscopic MPEG-2, stereoscopic MPEG-4 or stereoscopic AVI video decoder, or whether a rendering method is interlaced, sync-double, page-flipping, red-blue anaglyph, red-cyan anaglyph, or red-yellow anaglyph.

Shown below is an example of syntax that expresses a description information structure of the user terminal characteristics which is managed by the video usage environment information managing portion 107, shown in FIG. 1, based on the definition of the XML schema.

```
<complexType name=“StereoscopicVideoDisplayType”>
  <sequence>
  <element name=“DisplayDevice”>
  <simpleType>
  <restriction base=“string”>
  <enumeration value=“Monoscopic”/>
  <enumeration value=“Stereoscopic”/>
  </restriction>
  </simpleType>
  </element>
  <element name=“StereoscopicDecoderType”
          type=“mpeg7:ControlledTermUseType”/>
  <element name=“RenderingFormat”>
  <simpleType>
  <restriction base=“string”>
  <enumeration value=“Interlaced”/>
  <enumeration value=“Sync-Double”/>
  <enumeration value=“Page-Flipping”/>
  <enumeration value=“Anaglyph-Red-Blue”/>
  <enumeration value=“Anaglyph-Red-Cyan”/>
  <enumeration value=“Anaglyph-Red-Yellow”/>
  </restriction>
  </simpleType>
  </element>
  </sequence>
</complexType>
```

Table 2 shows elements of user characteristics.

TABLE 2

| | Elements | Data type |
|---|---|---|
| StereoscopicvideoDisplayType | Display Type | String |
| | StereoscopicDecoderType | Mpeg7:ControlledTermuseType |
| | Rendering Format | String |

DisplayType represents whether display hardware of the user terminal is monoscopic or stereoscopic.

StreoscopicDecoderType represents whether the video decoder is a stereoscopic MPEG-2, stereoscopic MPEG-4 or stereoscopic AVI video decoder

RenderingFormat represents whether the video decoder is a stereoscopic MPEG-2, stereoscopic MPEG-4 or stereoscopic AVI video decoder, or whether a rendering method is interlaced, sync-double, page-flipping, red-blue anaglyph, red-cyan anaglyph, or red-yellow anaglyph.

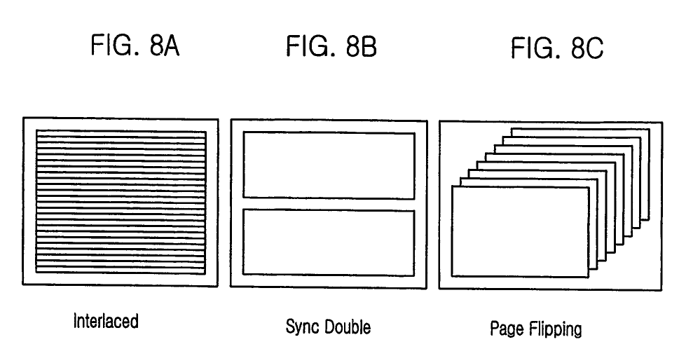

FIGS. 8A to 8C are exemplary diagrams illustrating rendering methods of 3D stereoscopic video signal in accordance with the present invention. Referring to FIGS. 8A to 8C, the rendering methods include interlaced, syn-Double and page-flipping.

Shown below is an example of syntax that expresses a description information structure of the user characteristics such as preference and favor of user when 2D video signal is adapted to a 3D stereoscopic video signal.

The syntax expresses that PrallaxType represents Negative Parallax, DepthRange is set to 0.7 and the maximum number of delayed frames is 15.

Also, the syntax expresses that the synthesized image is chosen among 3D stereoscopic video signals.

```
<StereoscopicVideoConversion>
  <From2DTo3DStereoscopic>
        <ParallaxType>Negative</ParallaxType>
        <DepthRange>0.7</DepthRange>
        <MaxDelayedFrame>15</MaxDelayedFrame>
  </From2DTo3DStereoscopic>
  <From3DStereoscopicTo2D>
  <LeftRightInterVideo>Intermediate</LeftRightInterVideo>
  </From3DStereoscopicTo2D>
</StereoscopicVideoConversion>
```

Shown below is an example of syntax that expresses a description information structure of the user terminal characteristics in case of a 3D stereoscopic video signal user terminal.

The user terminal supports a monoscopic display, an MPEG-1 video decoder and anaglyph. These user terminal characteristics are used for 3D stereoscopic video signal users.

```
      <StereoscopicVideoDisplay>
      <DisplayDevice>Monoscopic</DisplayDevice>
            <StereoscopicDecoderType
href=“urn:mpeg:mpeg7:cs:VisualCodingFormatCS:2001:1”>
            <mpeg7:Name xml:lang=“en”>MPEG-1 Video
            </mpeg7:Name>
      </StereoscopicDecoderType>
      <RenderingFormat>Anaglyph</RenderingFormat>
      </StereoscopicVideoDisplay>
```

The method of the present invention can be stored in a computer-readable recording medium, e.g., a CD-ROM, a RAM, a ROM, a floppy disk, a hard disk, and an optical/magnetic disk.

As described above, the present invention can provide a service environment that can adapt a 2D video content to a 3D stereoscopic video content and a 3D stereoscopic video content to a 2D video content by using information on preference and favor of a user and user terminal characteristics in order to comply with different usage environments and characteristics and preferences of the user.

Also, the technology of the present invention can provide one single source to a plurality of usage environment by adapting the 2D video signal or 3D stereoscopic video content to different usage environments and users with various characteristics and tastes. Therefore, the cost for producing and transmitting a plurality of video contents can be saved and the optimal video contents service can be provided by satisfying the preferences of user and overcoming limitation of user terminal capabilities. While the present invention has been shown and described with respect to the particular embodiments, it will be apparent to those skilled in the art that many changes and modifications may be made without departing from the spirit and scope of the invention as defined in the appended claims.

1. An apparatus for adapting a two-dimensional (2D) or three-dimensional (3D) stereoscopic video signal for single-source multi-use, comprising:
a video usage environment information managing means for acquiring, describing and managing user characteristic information from a user terminal; and
a video adaptation means for adapting the video signal to the video usage environment information to generate an adapted 2D video signal or 3D stereoscopic video signal and outputting the adapted video signal to the user terminal.

2. The apparatus as recited in claim 1, wherein the user characteristic information includes user preference such as positive parallax or negative parallax in case of adapting a 2D video signal to a 3D stereoscopic video signal.

3. The apparatus as recited in claim 2, wherein the user characteristic information is expressed in an information structure as:
<element name=“ParallaxType”>
<SimpleType>
<restriction base=“string”>
<enumeration value=“Positive”/>
<enumeration value=“Negative”/>
</restriction>
</simpleType>
</element>.

4. The apparatus as recited in claim 1, wherein the user characteristic information includes user preference such as parallax depth of a 3D stereoscopic video signal in case of adapting a 2D video signal to a 3D stereoscopic video signal.

5. The apparatus as recited in claim 4, wherein the user characteristic information is expressed in an information structure as:
```
      <element
            name=“DepthRange”
type=“mpeg7:zeroToOneType”/> .
```

6. The apparatus as recited in claim 1, wherein the user characteristic information includes user preference such as the maximum number n of delayed frame Iₖ₋ₙ in case of adapting a 2D video signal to a 3D stereoscopic video signal.

7. The apparatus as recited in claim 6, wherein the user characteristic information is expressed in an information structure as:
```
      <element
            name=“MaxDelayedFrame”
type=“nonNegativeInteger”/>.
```

8. The apparatus as recited in claim 1, wherein the user characteristic information includes user preference such as which image signal to choose as a 2D video signal in case of adapting a 3D stereoscopic video signal to a 2D video signal.

9. The apparatus as recited in claim 8 wherein the user characteristic information is expressed in an information structure as:
<element name=“LeftRightInterVideo”>
<simpleType>
<restriction base=“string”>
<enumeration value=“Left”/>
<enumeration value=“Right”/>
<enumeration value=“Intermediate”/>
</restriction>
</simpleType>
</element>.

10. An apparatus for adapting a 2D video signal or a 3D stereoscopic video signal for single-source multi-use, comprising:
a video usage environment information managing means for acquiring, describing and managing user terminal characteristic information from a user terminal; and
a video adaptation means for adapting the video signal to the video usage environment information to generate an adapted 2D video signal or 3D stereoscopic video signal and outputting the adapted video signal to the user terminal.

11. The apparatus as recited in claim 10, wherein the user characteristic information includes information on display device supported by the user terminal.

12. The apparatus as recited in claim 11, wherein the user characteristic information is expressed in an information structure as:
```
<element name=“DisplayDevice”>
  <simpleType>
  <restriction base=“string”>
  <enumeration value=“Monoscopic”/>
  <enumeration value=“Stereoscopic”/>
  </restriction>
  </simpleType>
</element>.
```

13. The apparatus as recited in claim 10, wherein the user characteristic information includes information on a 3D video decoder.

14. The apparatus as recited in claim 13, wherein the user characteristic information is expressed in an information structure as:
<element name=“StereoscopicDecoderType”
type=“mpeg7:ControlledTermUseType”/>.

15. The apparatus as recited in claim 10, wherein the user characteristic information includes information on rendering method of 3D video.

16. The apparatus as recited in claim 15, wherein the user characteristic information is expressed in an information structure as:
<element name=“RenderingFormat”>
<simpleType>
<restriction base=“string”>
<enumeration value=“Interlaced”/>
<enumeration value=“Sync-Double”/>
<enumeration value=“Page-Flipping”/>
<enumeration value=“Anaglyph-Red-Blue”/>
<enumeration value=“Anaglyph-Red-Cyan”/>
<enumeration value=“Anaglyph-Red-Yellow”/>
</restriction>
</simpleType>
</element>.

17. A method for adapting a 2D video signal or a 3D stereoscopic video signal for single-source multi-use, comprising the steps of:
a) acquiring, describing and managing user characteristic information from a user terminal; and
b) adapting the video signal to the video usage environment information to generate an adapted 2D video signal or 3D stereoscopic video signal and outputting the adapted video signal to the user terminal.

18. The method as recited in claim 17, wherein the user characteristic information includes user preference such as positive parallax or negative parallax in case of adapting a 2D video signal to a 3D stereoscopic video signal.

19. The method as recited in claim 18, wherein the user characteristic information is expressed in an information structure as:
<element name=“ParallaxType”>
<simpleType>
<restriction base=“string”>
<enumeration value=“Positive”/>
<enumeration value=“Negative”/>
</restriction>
</simpleType>
</element>.

20. The method as recited in claim 17, wherein the user characteristic information includes user preference such as parallax depth of 3D stereoscopic video signal in case of adapting a 2D video signal to a 3D stereoscopic video signal.

21. The apparatus as recited in claim 20, wherein the user characteristic information is expressed in an information structure as:
<element
name=“DepthRange”
type=“mpeg7:zeroToOneType”/>.

22. The apparatus as recited in claim 17, wherein the user characteristic information includes user preference such as the maximum number n of delayed frame Iₖ₋ₙ in case of adapting a 2D video signal to a 3D stereoscopic video signal.

23. The method as recited in claim 22, wherein the user characteristic information is expressed in an information structure as:
<element
name=“MaxDelayedFrame”
type=“nonNegativeInteger”/>.

24. The apparatus as recited in claim 17, wherein the user characteristic information includes user preference such as which image signal to choose as 2D video signal in case of adapting a 3D stereoscopic video signal to a 2D video signal.

25. The method as recited in claim 24, wherein the user characteristic information is expressed in an information structure as:
<element name=“LeftRightInterVideo”>
<simpleType>
<restriction base=“string”>
<enumeration value=“Left”/>
<enumeration value=“Right”/>
<enumeration value=“Intermediate”/>
</restriction>
</simpleType>
</element>.

26. A method for adapting a 2D video signal or a 3D stereoscopic video signal for single-source multi-use, comprising the steps of:
a) acquiring, describing and managing user terminal characteristic information from a user terminal; and
b) adapting the video signal to the video usage environment information to generate an adapted 2D video signal or 3D stereoscopic video signal and outputting the adapted video signal to the user terminal.

27. The method as recited in claim 26, wherein the user characteristic information includes information on a display device supported by the user terminal.

28. The method as recited in claim 27, wherein the user characteristic information is expressed in an information structure as:
<element name=“DisplayDevice”>
<simpleType>
<restriction base=“string”>
<enumeration value=“Monoscopic”/>
<enumeration value=“Stereoscopic”/>
</restriction>
</simpleType>
</element>.

29. The method as recited in claim 26, wherein the user characteristic information includes information on a 3D video decoder.

30. The method as recited in claim 29, wherein the user characteristic information is expressed in an information structure as:
<element name=“StereoscopicDecoderType”
type=“mpeg7:ControlledTermUseType”/>.

31. The method as recited in claim 26, wherein the user characteristic information includes information on rendering method of 3D video.

32. The method as recited in claim 31, wherein the user characteristic information is expressed in an information structure as:
<element name=“RenderingFormat”>
<simpleType>
<restriction base=“string”>
<enumeration value=“Interlaced”/>
<enumeration value=“Sync-Double”/>
<enumeration value=“Page-Flipping”/>
<enumeration value=“Anaglyph-Red-Blue”/>
<enumeration value=“Anaglyph-Red-Cyan”/>
<enumeration value=“Anaglyph-Red-Yellow”/>
</restriction>
</simpleType>
</element>.

33. A computer-readable recording medium for recording a program that implements a method for adapting a 2D video signal or a 3D stereoscopic video signal for single-source multi-use, the method comprising the steps of:
a) acquiring, describing and managing user characteristic information from a user terminal; and
b) adapting the video signal to the video usage environment information to generate an adapted 2D video signal or 3D stereoscopic video signal and outputting the adapted video signal to the user terminal.

34. A computer-readable recording medium for recording a program that implements a method for adapting a 2D video signal or a 3D stereoscopic video signal for single-source multi-use, the method comprising the steps of:
a) acquiring, describing and managing user terminal characteristic information from a user terminal; and
b) adapting the video signal to the video usage environment information to generate an adapted 2D video signal or 3D stereoscopic video signal and outputting the adapted video signal to the user terminal.
